(19) United States
(12) Patent Application Publication
(10) Pub. No.: US 2026/0285136 A1
(43) Pub. Date: Sep. 24, 2026

(54) ADJUSTABLE-SPACING CLAMPING DEVICE FOR CAR COVER PARTS

(71) Applicant: Hongbo WU, Ningbo (CN)

(72) Inventor: Hongbo WU, Ningbo (CN)

(21) Appl. No.: 19/445,530

(22) Filed: Jan. 10, 2026

(30) Foreign Application Priority Data
Mar. 18, 2025 (CN) 202520479910.6

(51) Int. Cl. B60J 7/185

(52) U.S. Cl. CPC B60J 7/185

(57) ABSTRACT

Provided herein is an adjustable-spacing clamping device for a car cover, comprising a first directional frame and a second directional frame, both used to engage the car cover; a latching member, one end of which is connected to the first directional frame and the other end to the second directional frame, so that the latching member, the first directional frame, and the second directional frame are assembled into a single integrated frame; a clamping mechanism acts on the integrated frame to clamp the integrated frame to an external support; the latching member has two or more receiving cavities, and the clamping mechanism is detachably connected to any one of the receiving cavities, with each receiving cavity forming a different gap with the first directional frame/second directional frame, eliminating the defects of loosening due to excessive gaps and inability to clamp due to excessive gaps.

### CROSS-REFERENCE TO RELATED APPLICATIONS

This application claims priority under 35 U.S.C. § 119(a) to Chinese Patent Application No. 202520479910.6, filed on Mar. 18, 2025, which is hereby incorporated by reference herein in its entirety.

### TECHNICAL FIELD

This disclosure relates to the technical field of fastening devices, and in particular to a clamping device for a cover piece with adjustable spacing.

### BACKGROUND ART

To assemble two originally separate objects into a single unit, a connection process is required, such as welding, fastener connections (e.g., screws), flange connections, or adhesive bonding. Welding and bonding are suitable for one-time connections without the need for disassembly, but their applications are relatively limited. Other connection methods also have their own limitations. The application scenario described in this application involves connecting an external first object and a second object. The first object is a fixed frame, and the second object is a movable cover. Pressure is applied to the fixed frame and the movable cover by a third-party device, reliably pressing them together. The movable cover then provides shelter and protection for the previously open space within the fixed frame. In other cases, the pressure is released by a third-party device, creating a gap between the fixed frame and the movable cover, allowing the movable cover to move and retract relative to the fixed frame, while exposing the space within the fixed frame.

Reference 1 to the above application scenario example, see patent CN217415587U, discloses an adjustable support assembly, including a carriage and a fixed cover plate, and further including: a first fixing frame, disposed at the bottom of the fixed cover plate, the first fixing frame being movably provided with a locking rod; a side frame, fixed to the inner boundary of the carriage; a second fixing frame, including a stop part that engages with the side frame, and a pressing part that abuts against the first fixing frame, the stop part engaging with the contour of the side frame and restricting the movement of the second fixing frame vertically, the pressing part having a strip hole for the locking rod to pass through, the locking rod being pressed against the carriage along with the fixed cover plate and passing through the strip hole; a fixing component, the fixing component being used to screw onto the locking rod after the locking rod passes through the strip hole, so as to press the first fixing frame onto the second fixing frame, facilitating the assembly of the fixed cover plate.

Reference 2 to the above application scenario example, see patent CN216783239U, which discloses an easy-to-operate vehicle cover fixing structure, including a longitudinally arranged frame, a latch connected to the frame, and a fixing component. The latch is provided with a mounting seat for arranging the fixing component. The fixing component includes: a screw, the mounting seat is provided with a channel for the screw to pass through laterally, the channel is provided with multiple limiting ribs that cooperate with the screw; a rotating rod, one end of the rotating rod is provided with a hinge joint connected to the screw, and the two limiting ribs form an adjustment area, the rotating rod moves back and forth toward the frame in the adjustment area; the other end of the rotating rod is provided with a clamping mechanism, the rotating rod rotates relative to the screw to make the clamping mechanism cooperate with the vehicle body, which facilitates installation and reduces movement.

In existing related documents 1 and 2, both allow for vertical distance adjustment to tighten or loosen the cargo cover. However, both have certain drawbacks in use. For example, different vehicle models have different dimensions, specifically variations in the shape and thickness of the cargo cover sidewalls. For instance, if a cargo cover fixing structure (latch) with a smaller spacing is applied to a thicker cargo cover sidewall, it cannot achieve the desired clamping and fixing function; conversely, if a cargo cover fixing structure (latch) with a larger spacing is applied to a smaller cargo cover sidewall, it will result in a loose fit and failure to clamp properly. Therefore, in existing technologies, each cargo cover fixing structure (latch) has only one mounting hole (equivalent to a storage slot) along the horizontal direction (generally transverse). Consequently, the position of the clamping block (clamping mechanism) in a single product is unique in the horizontal direction (generally transverse), resulting in a unique distance between it and the cargo cover sidewall during use. This means that a single product can only be used with a specific vehicle. Therefore, multiple products of different sizes need to be customized to meet the needs of different car models, which leads to a significant increase in production and usage costs.

### SUMMARY OF THE INVENTION

In order to overcome the above-mentioned shortcomings of the prior art, the disclosure provides a clamping device for a box cover with adjustable spacing.

The technical solution of this disclosure to solve its technical problem is: a clamping device for a box cover with adjustable spacing, comprising:
both the first and second directional frames are used to fit the cover parts;
a latching member, one end of which is connected to a first directional frame and the other end of which is connected to a second directional frame, so that the latching member, the first directional frame and the second directional frame are assembled into an integral frame;
the clamping mechanism acts on the overall frame to clamp the overall frame to the external support;
the latching member has two or more receiving cavities, and the clamping mechanism is detachably connected to any one of the receiving cavities, with each receiving cavity forming a different distance from the first direction frame/second direction frame.

Specifically, each of the aforementioned receiving cavities includes a communicating major diameter section and a minor diameter section, the major diameter section having a first opening at the end away from the minor diameter section, the minor diameter section having a second opening at the end away from the major diameter section, and the lower end of the minor diameter section having a third opening, and the third opening being at least partially the same as the major diameter section.

A preferred embodiment of the clamping mechanism is that the clamping mechanism includes at least a connecting rod, a pivot shaft mounted on the upper end of the connecting rod, and a clamping block sleeved on the connecting rod.

The pivot shaft is installed into the large-diameter section after passing through the first opening, and the connecting rod can enter into the small-diameter section through the second opening.

Furthermore, the clamping mechanism also includes an operating handle, which acts on the clamping block to adjust the relative positional relationship between the clamping block and the latching member.

More specifically, the clamping block is provided with a through hole, and the connecting rod passes through at least partially through the through hole.

The operating handle is provided with a rotating hole, a rotating shaft is connected to the rotating hole, and a threaded adjustment hole is provided on the rotating shaft. The connecting rod is provided with a threaded section, and the threaded section and the threaded adjustment hole form a threaded connection.

The rotating shaft is horizontally arranged.

The length of the threaded section is greater than the depth of the threaded hole.

A preferred embodiment of the operating handle is that the operating handle is provided with a movable locking buckle, which acts on the clamping block to form an interference limiting state and an interference release state between the locking buckle and the clamping block.

The operating handle can have at least a clamping state and a relaxed state relative to the clamping block.

When the locking buckle and the clamping block are in the interference limiting state, the operating handle cannot rotate relative to the clamping block, thereby restricting the operating handle from switching between the clamping and loosening states.

When the locking buckle and clamping block are in a state of disengagement, the operating handle can rotate relative to the clamping block, thereby allowing the operating handle to switch between a tightened state and a relaxed state.

In some preferred embodiments of the disclosure, the inner wall of the small diameter section is provided with a limiting rib, which divides the small diameter section into a small diameter storage section and a small diameter working section.

In some preferred embodiments of the disclosure, the latching member is provided with an opening slot, the opening slot communicating with the first opening of each receiving cavity, and a cover plate is detachably mounted on the opening slot.

When the cover plate is fitted onto the opening slot, the cover plate will cover multiple first openings.

Preferably, the latching member and the cover plate are provided with matching fixing holes and positioning holes, the fixing holes are located in the middle of the opening groove, and the positioning holes are symmetrically distributed on both sides of the opening groove.

A positioning pin is inserted into the positioning hole so that the cover plate and the latching component form a pre-positioned connection.

Fasteners are inserted into the fixing holes to form a fixed connection between the cover plate and the latching member.

In some preferred embodiments of the disclosure, the end of the latching member near the first direction frame forms a slider end, the first direction frame is provided with a sliding groove, and the slider end extends into the sliding groove to form a sliding fit.

The beneficial effects of this disclosure are as follows: the latching member has two or more receiving cavities, the clamping mechanism is detachably connected to any one of the receiving cavities, and each receiving cavity forms a different distance from the first direction frame/second direction frame. During use, the user can selectively assemble the clamping mechanism into a more suitable receiving cavity according to their own needs (e.g., the thickness of their vehicle's cargo box) to match the distance between the clamping mechanism and the external support, ensuring that the clamping mechanism can stably and reliably clamp the entire frame to the external support, eliminating the defects of loosening due to excessive gaps or failing to clamp due to insufficient gaps.

### BRIEF DESCRIPTION OF DRAWINGS

FIG. 1 is a schematic diagram of the structure of the disclosure (using a smaller spacing of the receiving cavity).

FIG. 2 is a schematic diagram of the structure of the disclosure (using a larger spacing of receiving cavities).

FIG. 3 is a comparative schematic diagram of the clamping mechanism when it is used with different receiving cavities.

FIG. 4 is an exploded view of the disclosure.

FIG. 5 is a cross-sectional view of the disclosure along the second direction.

FIG. 6 is a cross-sectional view of the disclosure along the first direction.

FIG. 7 is a structural diagram of the connecting rod when it is fitted with the small-diameter storage section.

FIG. 8 is a schematic diagram of the structure when the end of the slider is engaged with the groove.

FIG. 9 is a structural schematic diagram of the disclosure (on the side where the cover plate is located).

FIG. 10 is a schematic diagram of the disassembly of the cover plate according to the disclosure.

FIG. 11 is a structural schematic diagram of one side of the latching member.

FIG. 12 is a schematic diagram of the structure on the other side of the latching member.

FIG. 13 is a comparative diagram showing the locking buckle in the interference limit state and the interference release state.

In the diagram: 1. First direction frame; 11. Slide groove; 2. Second direction frame; 3. Cover piece; 4. Latch member; 41. Receiving cavity; 411. Large diameter section; 4111. First opening; 412. Small diameter section; 4121. Second opening; 4122. Third opening; 4123. Limiting rib; 4124. Small diameter storage section; 4125. Small diameter working section; 42. Slider end; 43. Opening slot; 44. Fixing hole; 45. Positioning hole; 5. Clamping mechanism; 51. Connecting rod; 511. Threaded section; 52. Pivot shaft; 53. Clamping block; 531. Through hole; 54. Operating handle; 541. Rotating hole; 55. Rotating shaft; 551. Threaded adjustment hole; 55a. Axis centerline; 56. Locking buckle; 56a. Interference limit state; 56b. Interference release state; 6. External support; 7. Cover plate; 71. Positioning pin; 72. Fastener; L. Spacing.

### DETAILED DESCRIPTION

The disclosure will be further described below with reference to the accompanying drawings and specific embodiments. It should be noted that the embodiments are merely specific illustrations of the disclosure, intended to enable those skilled in the art to better understand the technical solutions of the disclosure, and should not be regarded as limitations on the disclosure.

In the description of this disclosure, it should be noted that the terms “center”, “upper”, “lower”, “left”, “right”, “vertical”, “horizontal”, “inner”, “outer”, etc., indicating the orientation or positional relationship are based on the orientation or positional relationship shown in the drawings, and are only for the convenience of describing this disclosure and simplifying the description, and do not indicate or imply that the device or element referred to must have a specific orientation, or be constructed and operated in a specific orientation, and therefore should not be construed as a limitation of this disclosure.

In the description of this disclosure, it should be noted that, unless otherwise explicitly specified and limited, the terms “installation,” “connection,” and “linking” should be interpreted broadly. For example, they can refer to a fixed connection, a detachable connection, or an integral connection; they can refer to a mechanical connection or an electrical connection; they can refer to a direct connection or an indirect connection through an intermediate medium; and they can refer to the internal connection of two components. Those skilled in the art can understand the specific meaning of the above terms in this disclosure based on the specific circumstances.

### Example 1

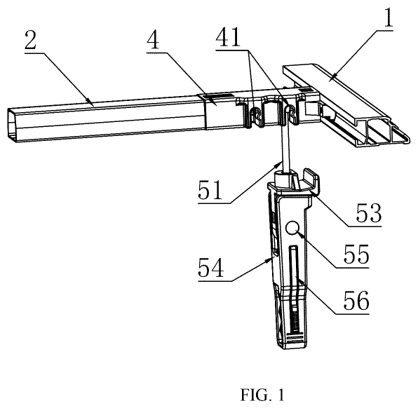

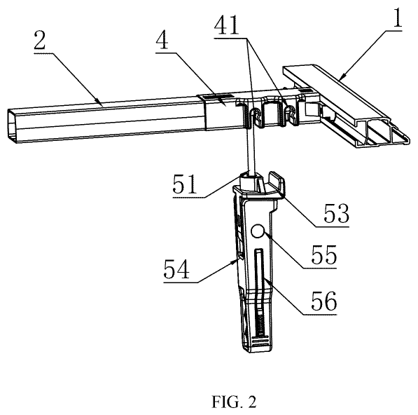

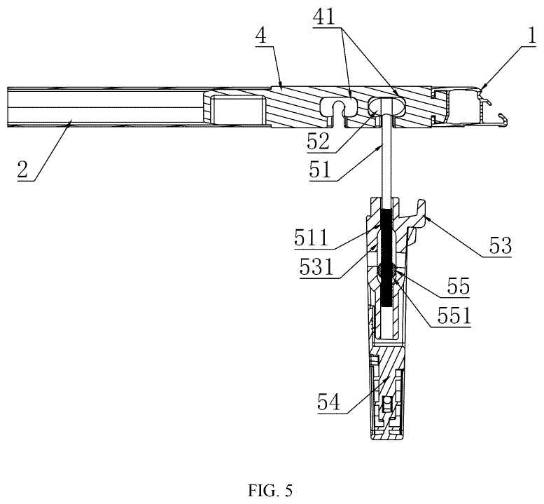

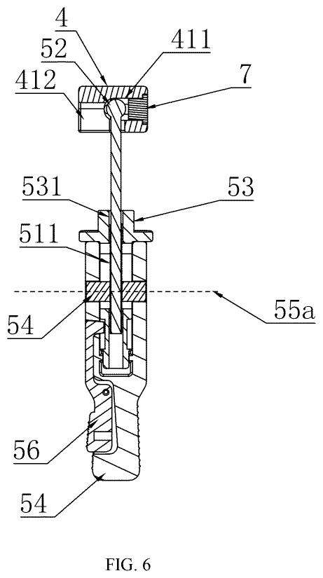

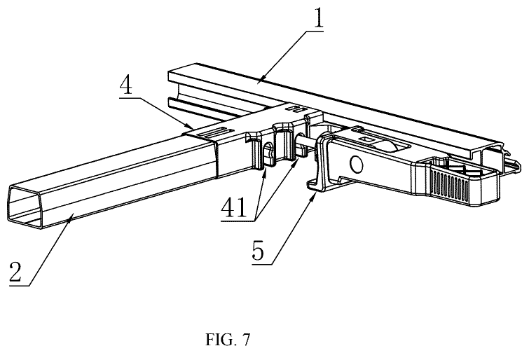

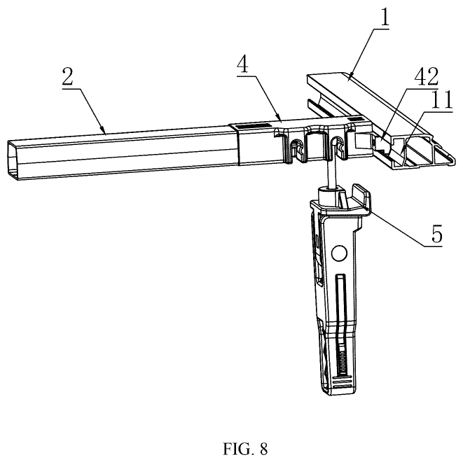

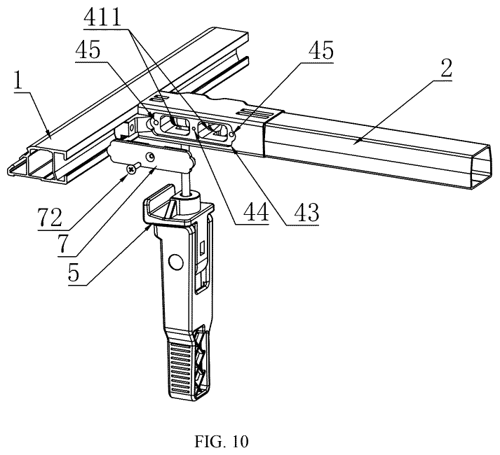

Referring to FIGS. 1-12, an adjustable-spacing compartment cover clamping device includes: a first-direction frame 1 and a second-direction frame 2, both used to engage the compartment cover 3; preferably, taking the FIGS. as an example, the first direction is longitudinal and the second direction is transverse. Of course, the first and second directions can also refer to other directions, and are not specifically limited here. A latching member 4 is connected at one end to the first-direction frame 1 and at the other end to the second-direction frame 2, so that the latching member 4, the first-direction frame 1, and the second-direction frame 2 are assembled into an integral frame; generally, the compartment cover 3 is fixed to the integral frame, so that the compartment cover 3 and the integral frame can move synchronously during assembly and disassembly. When the integral frame with the compartment cover 3 is assembled onto the wall of an open compartment (external support 6), it can provide shelter and protection for the open compartment. The material of the compartment cover 3 is not limited, and can be made of plastic, leather, metal, rubber, etc. The clamping mechanism 5 acts on the overall frame. When the overall frame is placed on the open carriage, although the two are in contact, relative displacement is likely to occur due to the lack of connection limit. Therefore, the clamping mechanism 5 can clamp the overall frame to the external support 6.

It is important to emphasize that the main difference from existing technologies lies in the fact that the latching member 4 has two or more receiving cavities 41, and the clamping mechanism 5 is detachably connected to any one of the receiving cavities 41. Furthermore, each receiving cavity 41 forms a different distance L between itself and the first direction frame 1/second direction frame 2. During use, the user can selectively assemble the clamping mechanism 5 into a more suitable receiving cavity 41 according to their own needs (e.g., the thickness of their vehicle's cargo box) to match the distance L between the clamping mechanism 5 and the external support 6. This ensures that the clamping mechanism 5 can stably and reliably clamp the entire frame to the external support 6, eliminating the defects of loosening due to excessive gaps or failing to clamp due to insufficient gaps.

It is worth mentioning that the latching member 4 has a slider end 42 at one end near the first direction frame 1. The first direction frame 1 has a sliding groove 11, and the slider end 42 extends into the sliding groove 11 to form a sliding fit. This allows adjustment of the longitudinal (first direction) position of the second direction frame 2 (latching member 4) relative to the first direction frame 1 to meet different needs. After adjustment, the clamping mechanism 5 performs the clamping function.

### Example 2

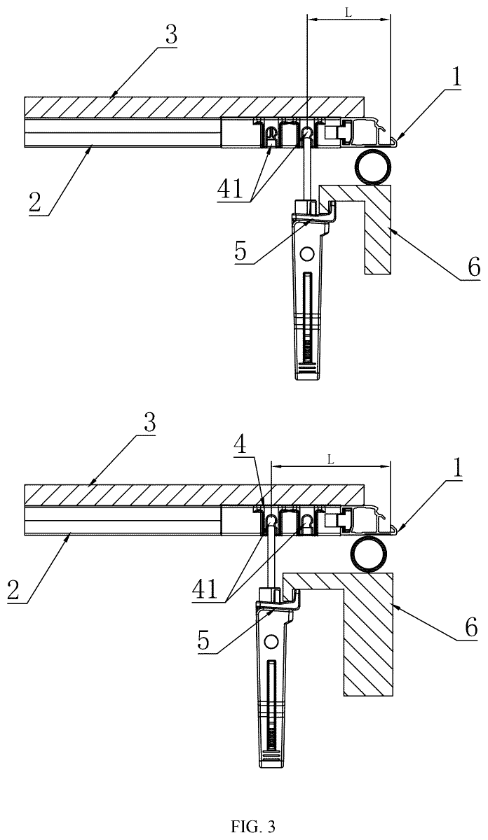

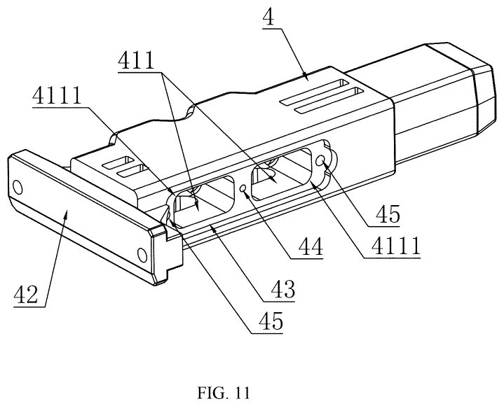

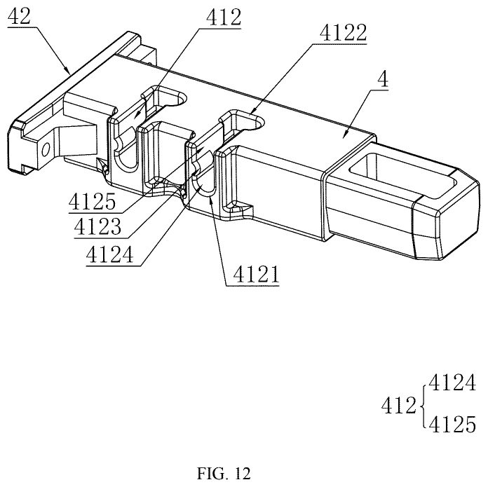

Referring to FIGS. 1 to 12, based on the structural scheme of Example 1, this embodiment provides a more preferred structure, as detailed below:
I. Regarding the receiving cavity 41: Referring to FIGS. 11 and 12, each of the receiving cavities 41 includes a communicating large-diameter section 411 and a small-diameter section 412. The end of the large-diameter section 411 away from the small-diameter section 412 has a first opening 4111, the end of the small-diameter section 412 away from the large-diameter section 411 has a second opening 4121, and the lower end of the small-diameter section 412 has a third opening 4122, and the third opening 4122 is at least partially the same as the large-diameter section 411.
II. Regarding the clamping mechanism 5: Referring to FIGS. 3 to 6, the clamping mechanism 5 includes at least a connecting rod 51, a pivot shaft 52 mounted on the upper end of the connecting rod 51, and a clamping block 53 sleeved on the connecting rod 51.

The pivot shaft 52 is installed into the large-diameter section 411 after passing through the first opening 4111. It should be noted that there is a certain clearance between the pivot shaft 52 and the large-diameter section 411, thus enabling rotation. On the other hand, the connecting rod 51 can enter the small-diameter section 412 through the second opening 4121, thus enabling installation. Furthermore, the connecting rod 51 and the pivot shaft 52 cooperate to achieve rotation, and the connecting rod 51 can switch positions between the second opening 4121 and the third opening 4122.

Furthermore, the clamping mechanism 5 also includes an operating handle 54, which acts on the clamping block 53 to adjust the relative positional relationship between the clamping block 53 and the latching member 4. Due to the limited shape, it is difficult for the user to hold and operate the connecting rod 51 or the clamping block 53. Therefore, the operating handle 54 is provided to facilitate the user's grip and to enable simple and effective driving of the clamping block 53.

More specifically, the clamping block 53 is provided with a through hole, and the connecting rod 51 is at least partially inserted through the through hole. It should be noted that the connecting rod 51 and the through hole are not fixed. The operating handle 54 is provided with a rotating hole 541, and a rotating shaft 55 is connected to the rotating hole 541. Thus, when the operating handle 54 is operated with the axis 55a of the rotating shaft 55 as the rotation center, the operating handle 54 can rotate independently relative to the clamping block 53; if the operating handle 54 is operated with the axis 55a (perpendicular to) a non-rotating shaft 55 as the rotation center, the operating handle 54 will drive the clamping block 53 to rotate together.

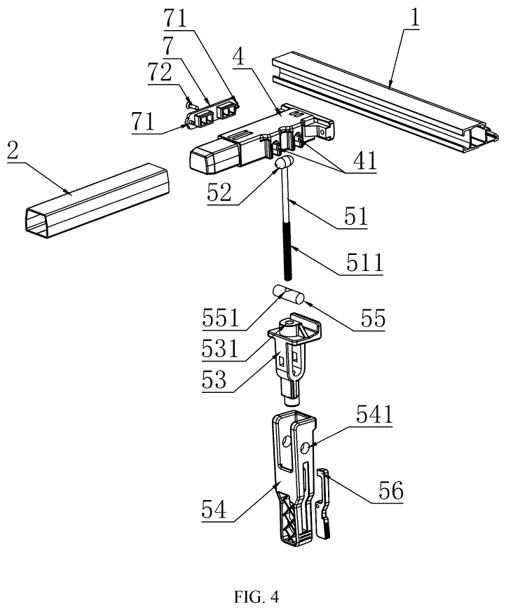

On the other hand, referring to FIGS. 4-6, the rotating shaft 55 has a threaded adjustment hole 551531, and the connecting rod 51 has a threaded section 511. The threaded section 511 and the threaded adjustment hole 551531 form a threaded connection. The rotating shaft 55 is horizontally arranged. The length of the threaded section 511 is greater than the depth of the threaded hole. When the operating handle 54 drives the clamping block 53 to rotate together, the threaded connection will change. Taking the latching member 4 as a fixed reference, the actual contact position between the threaded adjustment hole 551531 and the threaded section 511 changes, causing the clamping block 53 to move closer to or further away from the latching member 4 to meet the thickness requirements of different external supports 6, frames, or cover parts 3.

### Example 3

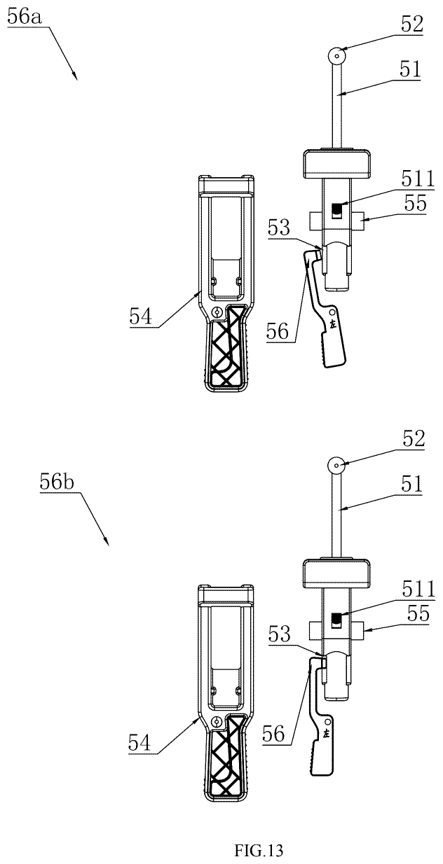

In this embodiment, a more preferred structural solution for the operating handle 54 is provided as follows: Referring to FIG. 13, the operating handle 54 is provided with a movable locking buckle 56. The locking buckle 56 acts on the clamping block 53, so that the locking buckle 56 and the clamping block 53 form an interference limiting state 56a and an interference release state 56b. In the interference limiting state 56a, the movement of the operating handle 54 is restricted, specifically, the operating handle 54 cannot be rotated relative to the clamping block 53 (with the axis 55a of the rotation shaft 55 as the rotation center); in the interference release state 56b, the operating handle 54 is released, specifically, the operating handle 54 can be rotated relative to the clamping block 53 (with the axis 55a of the rotation shaft 55 as the rotation center). On the other hand, the operating handle 54 can have at least a clamping state and a slack state relative to the clamping block 53 (for details, please refer to patent document CN117889127A); in the clamping state, the clamping block 53 cannot move, so as to ensure that it continuously and reliably performs the clamping function; in the slack state, the clamping block 53 can move, thereby realizing the subsequent disassembly and assembly functions.

The specific working principle is as follows:

When the locking buckle 56 and the clamping block 53 are in the interference limiting state 56a, the operating handle 54 cannot rotate relative to the clamping block 53, thereby restricting the operating handle 54 from switching between the clamping state and the loosening state.

When the locking buckle 56 and the clamping block 53 are in the state of disengagement 56b, the operating handle 54 can rotate relative to the clamping block 53, thereby allowing the operating handle 54 to switch between the clamping state and the loosening state.

It is worth noting that, referring to FIG. 12, the inner wall of the small-diameter section 412 is provided with a limiting rib 4123, which divides the small-diameter section 412 into a small-diameter storage section 4124 and a small-diameter working section 4125. The limiting rib 4123 forms an interference fit with the connecting rod 51. Therefore, when the user operates, a certain force needs to be applied to overcome the resistance, so that the connecting rod 51 can move between the small-diameter storage section 4124 and the small-diameter working section 4125 through the limiting rib 4123. More specifically, when the connecting rod 51 is in the small-diameter storage section 4124, the clamping block 53 is parallel to the cover piece 3, and the clamping block 53 will not have a clamping effect. Therefore, the operating handle 54 and the clamping mechanism 5 are in a storage state. When the connecting rod 51 is in the small-diameter working section 4125, the clamping block 53 is perpendicular to the cover piece 3, and the clamping block 53 can perform the function of clamping the entire frame to the external support 6.

### Example 4

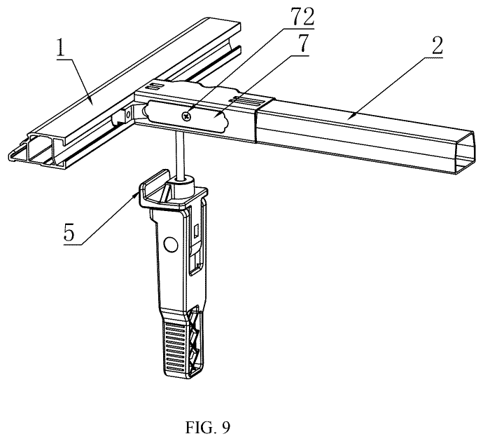

In this embodiment, an assembly structure scheme for some components is provided, as follows: Referring to FIGS. 9 to 12, the latching member 4 is provided with an opening groove 43, which communicates with the first opening 4111 of each receiving cavity 41, and a cover plate 7 is detachably mounted on the opening groove 43; when the cover plate 7 is mounted on the opening groove 43, the cover plate 7 covers the multiple first openings 4111 to prevent the pivot shaft 52 from falling off; when disassembly and assembly are required, the cover plate 7 is first removed from the opening groove 43, at which time the first opening 4111 of each receiving cavity 41 will be exposed to the outside, so that the user can disassemble and assemble the pivot shaft 52.

Preferably, the latching member 4 and the cover plate 7 are provided with matching fixing holes 44 and positioning holes 45. The fixing holes 44 are located in the middle of the opening groove 43, and the positioning holes 45 are symmetrically distributed on both sides of the opening groove 43. During assembly, a positioning pin 71 is first inserted into the positioning hole 45 to form a pre-positioning connection between the cover plate 7 and the latching member 4; then, a fastener 72 (preferably a screw) is inserted into the fixing hole 44 to form a fixed connection between the cover plate 7 and the latching member 4. Under the action of the positioning pin 71, a quick positioning function is achieved; the positioning pin 71, together with one fastener 72 (in traditional structures, there is no positioning pin 71, and generally two fasteners 72 are required), can achieve a quick fixing effect.

Preferably, the positioning pin 71 and the cover plate 7 are integrally formed from the same material, which makes production and assembly more efficient.

It is worth noting that the other technical solutions of this disclosure are all prior art, and therefore will not be described in detail.

The above description is only a preferred embodiment of the disclosure. It should be noted that those skilled in the art can make several improvements and modifications without departing from the concept of the disclosure, and these improvements and modifications should also be considered within the scope of protection of the disclosure.

What is claimed is:

1. A clamping device for a compartment cover with adjustable spacing, comprising:
both the first and second directional frames are used to fit the cover parts;
a latching member, one end of which is connected to a first directional frame and the other end of which is connected to a second directional frame, so that the latching member, the first directional frame and the second directional frame are assembled into an integral frame;
the clamping mechanism acts on the overall frame to clamp the overall frame to the external support;
wherein: the latching member has two or more receiving cavities, the clamping mechanism is detachably connected to any one of the receiving cavities, and each receiving cavity forms a different distance from the first direction frame/second direction frame.

2. The adjustable-spacing box cover clamping device according to claim 1, wherein:
each of the receiving cavities includes a communicating large-diameter section and a small-diameter section, the end of the large-diameter section away from the small-diameter section has a first opening, the end of the small-diameter section away from the large-diameter section has a second opening, the lower end of the small-diameter section has a third opening, and the third opening is at least partially the same as the large-diameter section.

3. The adjustable-spacing box cover clamping device according to claim 2, wherein: the clamping mechanism includes at least a connecting rod, a pivot shaft assembled on the upper end of the connecting rod, and a clamping block sleeved on the connecting rod;
the pivot shaft is installed into the large-diameter section after passing through the first opening, and the connecting rod can enter into the small-diameter section through the second opening.

4. The adjustable-spacing box cover clamping device according to claim 3, wherein: the clamping mechanism further includes an operating handle, the operating handle acting on the clamping block to adjust the relative positional relationship between the clamping block and the latching member.

5. The adjustable-spacing box cover clamping device according to claim 4, wherein: the clamping block is provided with a through hole, and the connecting rod is at least partially inserted into the through hole;
the operating handle is provided with a rotating hole, a rotating shaft is connected to the rotating hole, and a threaded adjustment hole is provided on the rotating shaft; the connecting rod is provided with a threaded section, and the threaded section and the threaded adjustment hole form a threaded connection;
the rotating shaft is horizontally arranged;
the length of the threaded section is greater than the depth of the threaded hole.

6. The adjustable-spacing box cover clamping device according to claim 4, wherein: the operating handle is provided with a movable locking buckle, the locking buckle acts on the clamping block so that the locking buckle and the clamping block form an interference limiting state and an interference release state;
the operating handle can have at least a clamping state and a relaxed state relative to the clamping block;
when the locking buckle and the clamping block are in the interference limiting state, the operating handle cannot rotate relative to the clamping block, thereby restricting the operating handle from switching between the clamping and loosening states;
when the locking buckle and clamping block are in a state of disengagement, the operating handle can rotate relative to the clamping block, thereby allowing the operating handle to switch between a tightened state and a relaxed state.

7. The adjustable-spacing box cover clamping device according to claim 2, wherein: a limiting rib is provided on the inner wall of the small-diameter section, and the limiting rib divides the small-diameter section into a small-diameter storage section and a small-diameter working section.

8. The adjustable-spacing box cover clamping device according to claim 2, wherein: the latching member is provided with an opening groove, the opening groove is connected to the first opening of each receiving cavity, and a cover plate is detachably mounted on the opening groove;
when the cover plate is fitted onto the opening slot, the cover plate will cover multiple first openings.

9. The adjustable-spacing box cover clamping device according to claim 8, wherein: the latching member and the cover plate are provided with matching fixing holes and positioning holes, the fixing holes are located in the middle of the opening groove, and the positioning holes are symmetrically distributed on both sides of the opening groove;
a positioning pin is inserted into the positioning hole so that the cover plate and the latching component form a pre-positioned connection;
fasteners are inserted into the fixing holes to form a fixed connection between the cover plate and the latching member.

10. The adjustable-spacing box cover clamping device according to claim 1, wherein:
the end of the latching member near the first direction frame forms a slider end, the first direction frame is provided with a sliding groove, and the slider end extends into the sliding groove to form a sliding fit.
